(19) United States
(12) Patent Application Publication
(10) Pub. No.: US 2009/0323114 A1
(43) Pub. Date: Dec. 31, 2009

(54) IMAGE FORMING APPARATUS

(76) Inventor: Kazuma OGAWA, Osaka (JP)

Correspondence Address: BIRCH STEWART KOLASCH & BIRCH, PO BOX 747, FALLS CHURCH, VA, 22040-0747, US

(21) Appl. No.: 12/493,921

(22) Filed: Jun. 29, 2009

(30) Foreign Application Priority Data
Jun. 30, 2008 (JP) 2008-171218

(51) Int. Cl. G06F 3/12

(52) U.S. Cl. 358/1.15

(57) ABSTRACT

Upon receiving, from a source image forming apparatus, image data that has been subjected to a preceding stage of image processing in the source image forming apparatus, an image forming apparatus of the present invention judges whether or not the image data has added thereto related information, such as the model name of the source image forming apparatus, which specifies the contents of the preceding stage of image processing. In a case where the image data has related information added thereto, the image forming apparatus performs an image conversion process on the image data according to the related information so that the image data can be compatibly subjected to a subsequent stage of image processing in the image forming apparatus, and then stores the image data in a hard disk. This makes it possible to output a high-quality image even in a case where an image processing operation for image-quality adjustment is separately carried out in different image forming apparatuses.

This Nonprovisional application claims priority under 35 U.S.C. § 119(a) on Patent Application No. 2008-171218 filed in Japan on Jun. 30, 2008, the entire contents of which are hereby incorporated by reference.

### TECHNICAL FIELD

The present invention relates to an image forming apparatus having an image filing function of storing and saving image data in a storage device.

### BACKGROUND ART

Among image forming apparatuses such as digital multifunction peripherals, there is an image forming apparatus having not only a copy function of printing out, on a recording paper sheet, an image read out with use of a scanning function, but also an image filing function of storing readout image data in a storage device such as a hard disk of the image forming apparatus.

Such an image filing function allows various operations such as sending a read image to another image forming apparatus so that the image is outputted from the destination image forming apparatus, sending a read image by attaching the image to a mail (scan-to-mail function), and sending a read image by facsimile (scan-to-FAX function).

Further, among image forming apparatuses, there is an image forming apparatus that includes a communications interface for receiving image data from a mobile communication terminal or an image input apparatus such as a digital camera and a digital video camera. Such an image forming apparatus can store the image data, which has been received via the communications interface, in a storage device such as a hard disk.

In a conventional image forming apparatus, a series of image processing operations is performed on inputted image data so that a high-quality image can be printed out. In an image forming apparatus having only a copy function, such a series of image processing operations is not carried out separately but carried out at one time. On the other hand, in an image forming apparatus having an image filing function, such a series of image processing operations is carried out separately in two stages, namely a preceding stage of image processing and a subsequent stage of image processing. In such an image forming apparatus, image data that has been subjected to only the preceding stage of image processing is stored in a storage device such as a hard disk.

The preceding stage of image processing includes such image processing operations as shading and correction γ correction. In the preceding stage of image processing, image data is processed as appropriate according to its various usages to such an extent that it becomes easy to use the image data according to its various usages.

The subsequent state of image processing includes such image processing operations as color correction, black generation and under color removal. The subsequent stage of image processing is carried out so that the image data can be printed out satisfactorily from an image forming section of the image forming apparatus.

In the image forming apparatus, the preceding and subsequent stages of image processing make it possible to satisfactorily print out an image corresponding to input image data.

For example, Japanese Patent Application Publication, Tokukai, No. 2005-144970 (Patent Literature 1) describes a technique for eliminating restrictions on print settings, which restrictions are generated due to a difference in ability between a source image forming apparatus which sends image data and a destination image forming apparatus which receives the image data.

According to Patent Literature 1, in a case where the destination image forming apparatus does not have an image editing function or an electronic sorting function, the source image forming apparatus carries out image editing and collating by page, and outputs the image data that has been subjected to these processing operations. In this arrangement, the destination image forming apparatus can output a 2-in-1 image even without a 2-in-1 function. Further, the destination image forming apparatus can output sorted printed materials even without the electronic sorting function.

However, such a conventional image forming apparatus has such a problem as below.

In a case where image data stored in a storage device by the image filing function (image data saved as a file) is sent (transferred) to another image forming apparatus and printed out from the destination image forming apparatus, or is sent by facsimile, a preceding stage of image processing carried out in the source image forming apparatus may not be compatible with a subsequent stage of image processing carried out in the destination image forming apparatus. This causes a problem of degradation in image quality.

Such a problem can be solved by standardizing the preceding stage of image processing so that all image forming apparatuses can carry out the same image processing operations. However, it is not practical in terms of cost to provide similar preceding image processing sections in both a high-performance model and a low-price model. Therefore, at the moment, different models of image forming apparatus differ in content of the preceding stage of image processing.

Patent Literature 1 only teaches that, in a case where image data that has been subjected to image-quality adjustment is to be further subjected to processing operations such as image editing and collating by page, the processing operations are carried out separately in the source image forming apparatus and the destination image forming apparatus. That is to say, Patent Literature 1 does not describe carrying out the image processing operation for image-quality adjustment separately in different apparatuses. Therefore, the problem cannot be solved by the invention of Patent Literature 1.

### SUMMARY OF THE INVENTION

The present invention has been accomplished in view of the problem, and an object of the present invention is to provide an image forming apparatus that can output a high-quality image even in a case where an image processing operation for image-quality adjustment is carried out separately in different image forming apparatuses.

In order to attain the object, a first image forming apparatus of the present invention is an image forming apparatus, having an image filing function of storing input image data in a storage section thereof, which carries out a series of image processing operations separately as a preceding stage of image processing and a subsequent stage of image processing in order to output an image of appropriate quality according to input image data, and which carries out the image filing function in such a manner as to store, in the storage section, image data that has been subjected to the preceding stage of image processing, the image forming apparatus comprising: an input section for receiving, from a source image forming apparatus, image data that has been subjected to a preceding stage of image processing in the source image forming apparatus; and image conversion means for performing an image conversion process on the image data so that the image data is compatibly subjected to the subsequent stage of image processing in the image forming apparatus, the image conversion means carrying out the image conversion process according to that related information, attached to the image data, which enables the image forming apparatus to determine contents of the preceding stage of image processing carried out in the source image forming apparatus.

In this arrangement, the image conversion means performs the image conversion process on the image data, which has been subjected to the preceding stage of image processing in the source image forming apparatus and supplied via the input section from the source image forming apparatus, so that the image data can be compatibly subjected to the subsequent stage of image processing in the image forming apparatus. In this regard, the image conversion means carries out the image conversion process according to the related information, attached to the image data, which enables the image forming apparatus to determine the contents of the preceding stage of image processing carried out in the source image forming apparatus.

Thus, even in a case where different image forming apparatuses carry out a preceding stage of image processing and a subsequent stage of image processing separately on image data, it is possible to output an image whose quality has been successfully adjusted.

In order to attain the object, a second image forming apparatus of the present invention is an image forming apparatus, having an image filing function of storing input image data in a storage section thereof, which carries out a series of image processing operations separately as a preceding stage of image processing and a subsequent stage of image processing in order to output an image of appropriate quality according to input image data, and which carries out the image filing function in such a manner as to store, in the storage section, image data that has been subjected to the preceding stage of image processing, the image forming apparatus comprising: an output section for outputting, to a destination image forming apparatus, image data that has been subjected to the preceding stage of image processing and stored in the storage section; and related-information adding means for adding, to image data that has been subjected to the preceding stage of image processing, related information that enables the destination image forming apparatus to determine contents of the preceding stage of image processing carried out in the image forming apparatus.

In this arrangement, the related-information adding means adds, to the image data to be stored in the storage section, the related information that enables the destination image forming apparatus to determine the contents of the preceding stage of image processing carried out in the image forming apparatus. That is to say, the image data that has been subjected to the preceding stage of image processing is stored in the storage section together with the related information that specifies the contents of the preceding stage of image processing.

In a case where the destination image forming apparatus is the first image forming apparatus of the present invention, the destination image forming apparatus can determine the contents of the preceding stage of image processing from the related information attached to the image data, and can carry out the image conversion process so that the image data can be compatibly subjected to a subsequent stage of image processing in a subsequent image processing section of the destination image forming apparatus.

Thus, even in a case where different image forming apparatuses carry out a preceding stage of image processing and a subsequent stage of image processing separately on image data, it is possible to output an image whose quality has been successfully adjusted.

In order to attain the object, a third image forming apparatus of the present invention is an image forming apparatus, having an image filing function of storing input image data in a storage section thereof, which carries out a series of image processing operations separately as a preceding stage of image processing and a subsequent stage of image processing in order to output an image of appropriate quality according to input image data, and which carries out the image filing function in such a manner as to store, in the storage section, image data that has been subjected to the preceding stage of image processing, the image forming apparatus comprising: an output section for outputting, to a destination image forming apparatus, image data that has been subjected to the preceding stage of image processing and stored in the storage section; and image conversion means for performing an image conversion process on the image data, which is to be outputted via the output section, so that the image data is compatibly subjected to a subsequent stage of image processing in the destination image forming apparatus, the image conversion means carrying out the image conversion process according to contents of a preceding stage of image processing that is carried out in the destination image forming apparatus.

In this arrangement, the image conversion means performs the image conversion process on the image data, which is to be outputted via the output section, so that the image data can be compatibly subjected to the subsequent stage of image processing in the destination image forming apparatus. In this regard, the image conversion means carries out the image conversion process according to the contents of the preceding stage of image processing that is carried out in the destination image forming apparatus.

Thus, even in a case where different image forming apparatuses carry out a preceding stage of image processing and a subsequent stage of image processing separately on image data, it is possible to output an image whose quality has been successfully adjusted.

Each of the means of the image forming apparatus may be realized by a computer. In this case, a program for causing a computer to operate as each of the means and a computer-readable storage medium in which the program has been stored are also encompassed in the scope of the present invention.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1(a)

FIG. 1(a) is a block diagram illustrating, in an image forming apparatus according to an embodiment of the present invention, an arrangement of an output processing section for outputting image data that has been subjected to image filing.

FIG. 1(b)

FIG. 1(b) is a block diagram illustrating, in an image forming apparatus according to an embodiment of the present invention, an arrangement of an input processing section for receiving image data that has been subjected to image filing in another image forming apparatus.

FIG. 2

FIG. 2 is a vertical cross-sectional view illustrating an arrangement of a main part of the image forming apparatus.

FIG. 3

FIG. 3 is a block diagram illustrating an arrangement and functions of an image processing system, provided in the image forming apparatus, which processes color image information.

FIG. 4

FIG. 4 is an explanatory diagram illustrating steps of an image filing function of storing, in a hard disk, image data read out by a color CCD.

FIG. 5

FIG. 5 is an explanatory diagram illustrating an arrangement of a JPEG compression section of the image forming apparatus.

FIG. 6

FIG. 6 is an explanatory diagram illustrating steps of a procedure in which the image forming apparatus performs a subsequent stage of image processing on image data stored in a hard disk and prints out the image data.

FIG. 7

FIG. 7 is an explanatory diagram illustrating the contents of header information prepended to image data that has been subjected to image filing and is to be outputted from the image forming apparatus.

FIG. 8

FIG. 8 is an explanatory diagram illustrating (i) steps of a procedure in two image forming apparatuses from filing image data to printing out the image data and (ii) steps of a procedure for transferring the filed image data between the two image forming apparatuses.

FIG. 9

FIG. 9 is an explanatory diagram illustrating how the image forming apparatus appropriately selects an image conversion process according to a model name included in header information prepended to external input image data saved as a file.

FIG. 10

FIG. 10 is a flow chart illustrating steps of a procedure in which the image forming apparatus outputs image data saved as a file.

FIG. 11

FIG. 11 is a flow chart illustrating steps of a procedure in which the image forming apparatus receives external image data saved as a file.

FIG. 12

FIG. 12 is a block diagram illustrating, in an image forming apparatus according to another embodiment of the present invention, an arrangement of an output processing section for outputting image data saved as a file.

FIG. 13

FIG. 13 is a flow chart illustrating steps of a procedure in which an image forming apparatus according to another embodiment of the present invention outputs image data saved as a file.

### DESCRIPTION OF EMBODIMENTS

### Embodiment 1

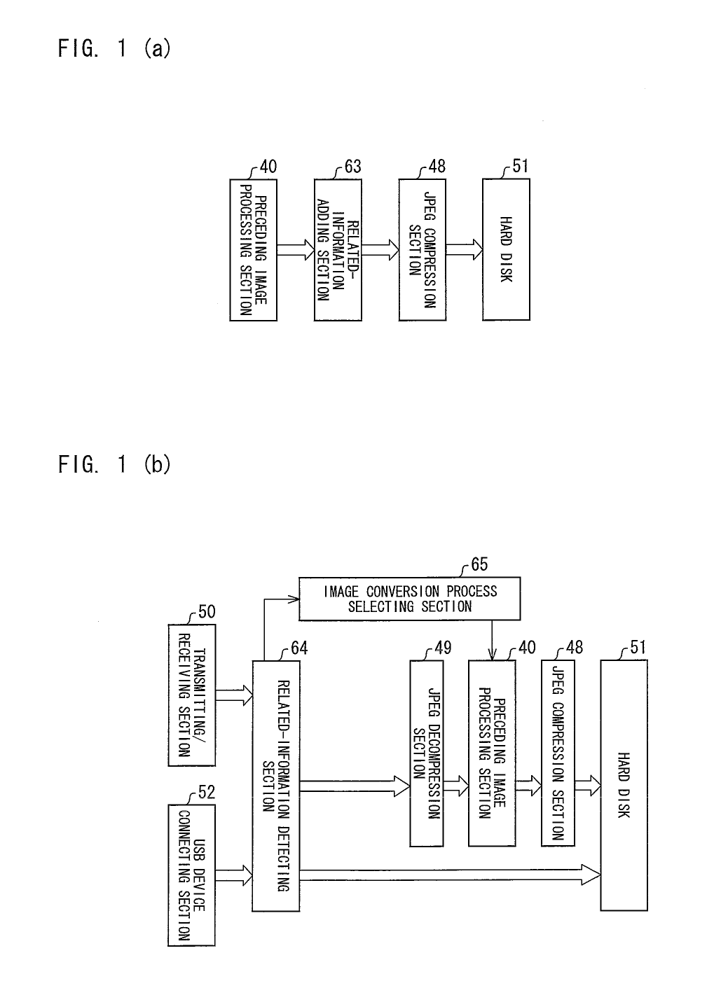

One embodiment of the present invention is described below with reference to FIGS. 1 through 11.

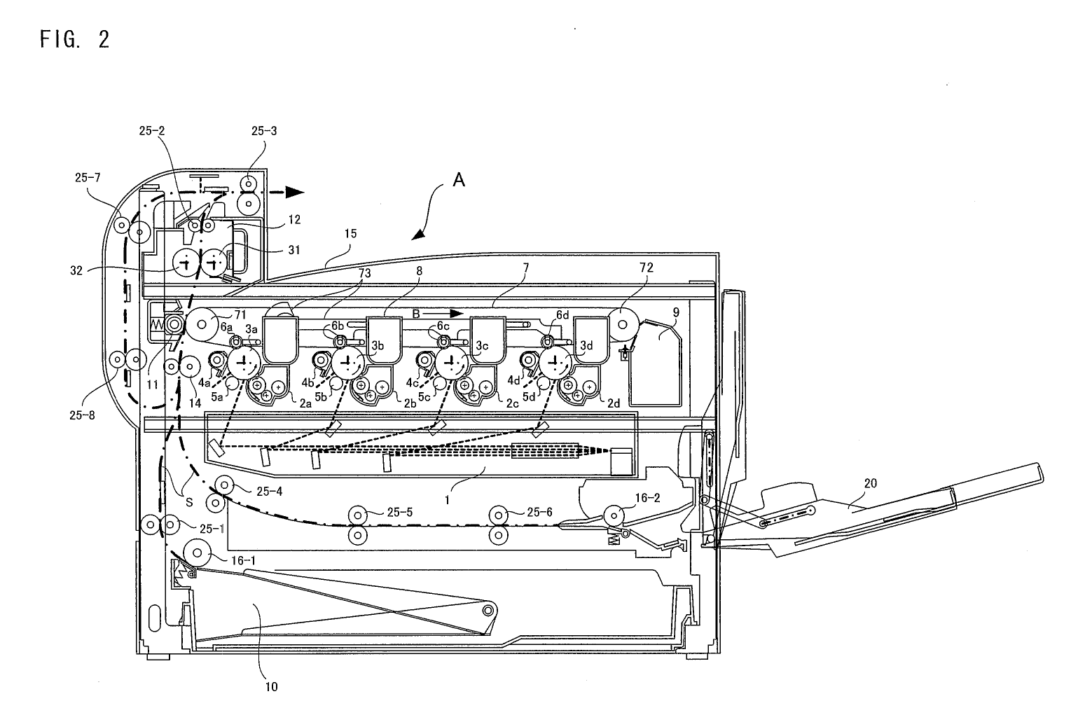

First, a schematic arrangement of an image forming apparatus in accordance with the present embodiment is described with reference to FIG. 2. FIG. 2 is a vertical cross-sectional view schematically illustrating an arrangement of an image forming apparatus A in accordance with the present embodiment.

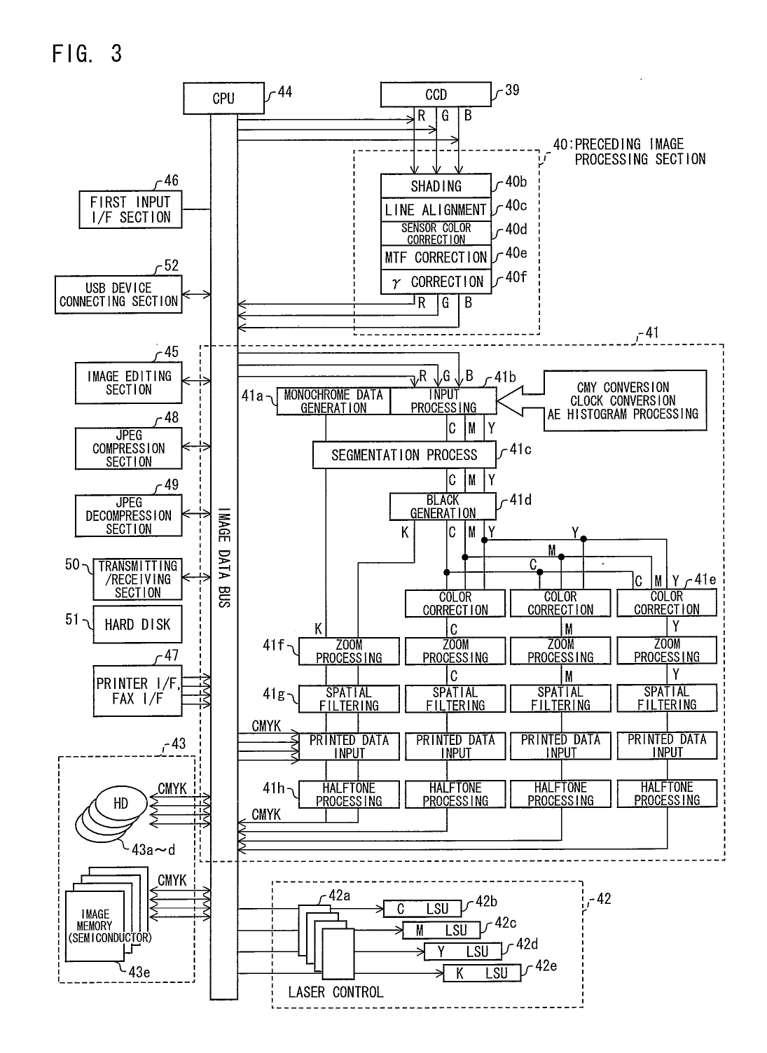

The image forming apparatus A is a digital color multifunction peripheral. When serving as a printer, the image forming apparatus A forms a full-color image or a monochrome image on a predetermined sheet (recording paper sheet) according to image data externally supplied (for example, from a terminal device such as a personal computer). The image forming apparatus A includes a 3-line color CCD 39 as shown in FIG. 3 (not shown in FIG. 2), so as to read out an image from a monochrome document or a color document and to form a monochrome image or a full-color image on a predetermined sheet (recording paper sheet) according to the image thus read out. In addition, the image forming apparatus A includes a second input interface section 47 as shown in FIG. 3, so as to (i) receive image data by facsimile and form an image according to the image data and (ii) send, to another image forming apparatus or by facsimile via an transmitting/receiving section 50, image data read out by the color CCD 39. Further, the image forming apparatus A may have not only a copy function of printing out, on a recording paper sheet, image data read out with use of a scanning function, but also an image filing function of storing readout image data in a storage device such as a hard disk of the image forming apparatus A.

As shown in FIG. 2, the image forming apparatus A includes a exposure unit 1, developing devices 2 (2a through 2d), photoreceptor drums 3 (3a through 3d) serving as image carriers, chargers 5 (5a through 5d), cleaner units 4 (4a through 4d), an intermediate transfer belt unit 8, a fixing device 12, a paper carrying path S, a paper feeding cassette 10, a paper output tray 15, and the like.

The image forming apparatus A processes image data corresponding to a color image formed with use of four colors, namely black (K), cyan (C), magenta (M), and yellow (Y). Therefore, the image forming apparatus A includes the four developing devices 2 (2a through 2d), the four photoreceptor drums 3 (3a through 3d), the four chargers 5 (5a through 5d), and the four cleaner units 4 (4a through 4d) so as to form four types of latent image respectively corresponding to the four colors. In FIG. 2, the suffix letters a, b, c, and d represent four image stations (image forming sections), namely black, cyan, magenta, and yellow image stations, respectively.

The photoreceptor drums 3 are disposed (mounted) in an upper part of the image forming apparatus A. On each of the photoreceptor drums 3, an electrostatic latent image corresponding to image data is formed by irradiation of a laser beam from the exposure unit 1. The chargers 5 are charging means for uniformly charging surfaces (photoreceptor layers) of the photoreceptor drums 3 at predetermined potentials. The chargers 5 may be contact-type chargers such as roller- or brush-type chargers as shown in FIG. 2, or may be noncontact-type chargers.

With the photoreceptor drums 3 charged, the exposure unit 1 irradiates the photoreceptor drums 3 with light according to image data inputted, thereby forming electrostatic latent images on the surfaces of the photoreceptor drums 3, according to the image data, respectively. The exposure unit 1 is provided for every color. FIG. 2 shows an example of the exposure unit 1 which is constituted by a laser scanning unit (LSU) including a laser irradiating section and a plurality of reflecting mirrors. Alternatively, the exposure unit 1 may be, for example, an EL or LED writing head including an array of light-emitting elements.

The developing devices 2 visualize, with four types of toner (developer) (black (K) toner, cyan (C) toner, magenta (M) toner, yellow (Y) toner), the electrostatic latent images formed on the photoreceptor drums 3, respectively. The cleaner units 4 remove and collect toner remaining on the surfaces of the photoreceptor drums 3 after development and image transfer.

The intermediate transfer belt unit 8, disposed above the photoreceptor drums 3, includes an intermediate transfer belt 7, an intermediate transfer belt driving roller 71, an intermediate transfer belt tension mechanism 73, an intermediate transfer belt driven roller 72, intermediate transfer rollers 6 (6a through 6d) serving as primary transfer rollers, and an intermediate transfer belt cleaning unit 9.

The intermediate transfer belt 7 is stretched over the intermediate transfer belt driving roller 71, the intermediate transfer belt tension mechanism 73, the intermediate transfer rollers 6, and the intermediate transfer belt driven roller 72. These members cause the intermediate transfer belt 7 to move in the direction of an arrow B as the intermediate transfer belt driving roller 71 drives the intermediate transfer belt 7 to rotate.

The intermediate transfer belt 7 is provided so as to be able to make contact with each of the photoreceptor drums 3. The toner images formed on the respective photoreceptor drums 3 with the use of the respective colors are sequentially transferred onto the intermediate transfer belt 7 in such a manner as to be superimposed onto one another. As a result, a multicolor toner image (composite image of multiple colors of toner) is formed on the intermediate transfer belt 7.

The transfer of the toner images onto the intermediate transfer belt 7 from the photoreceptor drums 3 is carried out by the intermediate transfer rollers 6, which are in contact with a back surface (inner surface) of the intermediate transfer belt 7. Applied to each of the intermediate transfer rollers 6 is a high-voltage transfer bias (high voltage whose polarity (+) is opposite to the charging polarity (−) of the toner) for the purpose of the transfer of the toner images. Each of the intermediate transfer rollers 6 can be shaped into a roller as shown in FIG. 2, or can be shaped into a brush or the like.

The toner images visualized in accordance with the respective colors on the respective photoreceptor drums 3a through 3d as described above are superimposed onto the intermediate transfer belt 7, whereby an image is formed according to the image data inputted to the apparatus. The image (composite image of multiple colors of toner) formed by superimposing the toner images as described above is moved by the movement of the intermediate transfer belt 7 to be transferred onto a paper sheet by the after-mentioned transfer roller 11, disposed in a position of contact between the paper sheet and the intermediate transfer belt 7, which constitutes a transfer unit.

Toner having adhered to the intermediate transfer belt 7 as a result of contact of the intermediate transfer belt 7 with the photoreceptor drums 3, or toner having not been transferred onto the paper sheet by the transfer roller 11 and thus remaining on the intermediate transfer belt 7, can cause a mixture of colors of toner in the next step. Therefore, such toner is removed and collected by the intermediate transfer belt cleaning unit 9.

The paper feeding cassette 10 is a cassette in which sheets (recording paper sheets) for use in image formation are stored. The paper feeding cassette 10 is provided at the bottom of the image forming apparatus A, that is to say, provided below the exposure unit 1. The paper output tray 15, provided on top of the image forming apparatus A, is a tray onto which a printed sheet is placed in a face-down manner. Provided so as to protrude from a main body of the image forming apparatus A is a manual feeding tray 20.

The image forming apparatus A is provided with the paper carrying path S through which a sheet is sent from the paper feeding cassette 10 or the manual feeding tray 20 to the paper output tray 15 via the transfer roller 11 and the fixing device 12. The paper carrying path S extends in a substantially vertical direction from a paper output section of the paper feeding cassette 10 to the paper output tray 15. Disposed along the paper carrying path S between the paper feeding cassette 10 and the paper output tray 15 are a pickup roller 16 (16-1), a registration roller 14, the transfer roller 11, the fixing device 12, a plurality of carrying rollers 25 (25-1, 25-2, 25-3) for carrying the sheet, and the like.

The plurality of carrying rollers 25, provided along the paper carrying path S, are small rollers for facilitating/assisting the carriage of the sheet. The pickup roller 16, provided at one end of the paper feeding cassette 10, is a feeding roller for feeding one sheet at a time from the paper feeding cassette 10 to the paper carrying path S.

The registration roller 14 serves to temporarily hold a sheet being carried through the paper carrying path S. Moreover, the registration roller 14 functions to carry the sheet to a transfer section (a nip section between the transfer roller 11 and the intermediate transfer belt driving roller 71) at such a timing that a head of the sheet is aligned with a head of the image formed on the intermediate transfer belt 7.

The fixing device 12 includes a heat roller 31, a pressure roller 32, and the like. The heat roller 31 and the pressure roller 32 rotate with the sheet sandwiched therebetween. The heat roller 31 is controlled by a control section according to a signal from a temperature detector (not shown) so as to have a predetermined fixing temperature. The sheet sandwiched between the heat roller 31 and the pressure roller 32 is subjected to heat and pressure, whereby the multicolor toner image transferred onto the sheet is melted, mixed, pressed, and then fixed onto the sheet by heat.

The sheet, onto which the multicolor toner image has been fixed, is carried through the paper carrying path S by the conveyer rollers 25, and then outputted onto the paper output tray 15 in such a manner that the multicolor toner image faces downward.

With reference to FIG. 3, the following describes an arrangement and functions of an image processing system, mounted in the image forming apparatus A, which processes color image information.

FIG. 3 is a block diagram illustrating an arrangement of an image processing system provided in the image forming apparatus A.

The image processing system includes a color CCD 39, a preceding image processing section 40, a subsequent image processing section 41, an image memory constituted by a hard disk device, a RAM (random access memory), or the like, an image data output section 42, a central processing unit (CPU) 44, an image editing section 45, first and second input interface sections 46 and 47, a JPEG compression section 48, a JPEG decompression section 49, a transmitting/receiving section 50, a hard disk 51, a USB device connecting section 52, and the like.

The color CCD 39 is a 3-line color CCD. The color CCD 39 reads out an image from a monochrome document or color document and then outputs line data including RGB color components into which the image has been decomposed.

The preceding image processing section 40 includes a shading correction section 40b, a line alignment section 40c, a sensor color correction section 40d, an MTF correction section 40e, a γ correction section 40f, and the like.

The shading correction section 40b corrects a line image level of the line data of the image read out by the color CCD 39. The line alignment section 40c, constituted by a line buffer and the like, corrects a misalignment among the line data of the image read out by the 3-line color CCD 39. The sensor color correction section 40d corrects color data of each color of the line data supplied from the color CCD 39. The MTF correction section 40e makes such a correction as to emphasize variations in signal of each pixel. The γ correction section 40f corrects the contrast of the image in order to improve visibility.

As will be described in detail below, in receiving, via the transmitting/receiving section 50, image data that has been subjected to a preceding stage of image processing in another image forming apparatus and storing (filing) the image data in the hard disk 51 of the image forming apparatus A, the central processing unit (CPU) 44 causes the preceding image processing section 40 to perform an image conversion process (file conversion process) on the image data.

The subsequent image processing section 41 includes a monochrome data generating section 41a, an input processing section 41b, a segmentation process section 41c, a black generation section 41d, a color correction circuit 41e, a zoom processing circuit 41f, a spatial filter 41g, a halftone processing section 41h, and the like.

The monochrome data generating section 41a generates monochrome data from RGB signals, i.e., color image signals supplied from the preceding image processing section 40. The input processing section 41b converts the RBG signals into YMC signals that can be respectively processed by the Y, M, and C image stations (image forming sections), and carries out clock conversion. The segmentation process section 41c separates inputted image data into a text region, a halftone dot region, and a photograph region. The black generation section 41d carries out an under-color removal process according to the YMC signals supplied from the input processing section 41a, and generates a K signal that can be processed by the K image station (image forming section) (black generation).

The color correction circuit 41e adjusts the colors of the YMC color image signals in accordance with Y, M, and C conversion tables, respectively. The zoom processing circuit 41f and the spatial filter 41g change a magnification of the inputted image data into one set in advance. The halftone processing section 41h reproduces tones by multi-level error diffusion and multi-level dithering.

The CMYK image data processed by and supplied from the halftone processing section 41h of the subsequent image processing section 41 are temporarily stored in the image memory 43 before being sent to the image data output section 42.

The image memory 43 includes four hard disks (rotating storage media) 43a, 43b, 43c, and 43d. The hard disks 43a through 43d sequentially receive 32-bit image data serially supplied from the subsequent image processing section 41, convert the 32-bit image data into 8-bit CMYK image data with the 32-bit data being temporarily stored in a buffer, and store and manage the 8-bit CMYK image data.

Further, the image memory 43 includes a delay buffer memory 43e, made of a semiconductor, in which to temporarily store the CMYK image data and from which to supply the CMYK image data to respective LSUs at different timings. The delay buffer memory 43e, which can adjust the timing of the supply of the image data, prevents a color aberration from being caused by the difference in position of the image stations. Furthermore, the image memory 43 includes an image synthesis memory (not shown) for synthesizing a plurality of images.

The image data output section 42 includes a laser control unit 42a and C, M, Y, and K LSUs 42b, 42c, 42d, and 43e. The laser control unit 42a carries out pulse-width modulation of the CMYK image data supplied from the halftone processing section 41h. The LSUs 42b through 42e carry out laser recording according to the pulse-width modulated CMYK image signals supplied from the laser control unit 42a, respectively.

The central processing unit (CPU) 44 controls the color CCD 39, the preceding image processing section 40, the subsequent image processing section 41, the image memory 43, the image data output section 42, the image editing section 45, the first and second input interface sections 46 and 47, the JPEG compression section 48, the JPEG decompression section 49, the transmitting/receiving section 50, the hard disk 51, the USB device connecting section 52, and the like according to a predetermined sequence.

Further, with use of the image synthesis memory, the CPU 44 carries out predetermined image editing of the image data temporarily stored in the image memory 43.

The first input interface section 46 is communications interface means for receiving image data (RGB signals) taken by an image input apparatus such as a mobile communication terminal, a digital camera, or a digital video camera.

The second input interface section 47 serves as a printer interface for receiving image data created by an external information processing apparatus, and also serves as a monochrome/color FAX interface for receiving image data transmitted by facsimile.

Image data supplied via the second input interface section 47 is already in the form of CMYK signals. As such, the CMYK signals are processed in the halftone processing section 41h and then temporarily stored and managed in the hard disks 43b, 43c, 43d, and 43e of the image memory 43, respectively.

In contrast, image data supplied via the first input interface section 46 is in the form of RGB signals. As such, the RGB signals are supplied to the subsequent image processing section 41 and subjected to color space conversion and the like so as to be converted into CMYK signals that can be respectively processed by the image stations of the image forming apparatus A, and then the CMYK signals are stored and managed in the hard disks 43b, 43c, 43d, and 43e, respectively.

In the image forming apparatus A of the present embodiment, the image data supplied via the first input interface section 46 can be compressed by the after-mentioned JPEG compression section 48 and then stored in the hard disk 51 (image filing).

If necessary, the JPEG compression section 48 receives image data supplied in the form of RGB signals from the preceding image processing section 40 and converts the image data into JPEG code by JPEG compression. The JPEG-compressed image data is sent to the hard disk 51.

The hard disk 51 is a file-saving storage section that is used for the image filing function. The hard disk 51 stores therein the JPEG-compressed image data.

The transmitting/receiving section (output section) 50 transmits, via a network to another image forming apparatus, the image data saved as a file in the file-saving hard disk 51. Further, the transmitting/receiving section 50 receives, via the network, image data saved as a file in another image forming apparatus, and then stores the image data in the hard disk 51.

The USB device connecting section (output section) 52 allows a USB memory to be connected to the hard disk 51. With the USB device connecting section 52, image data saved as a file in the hard disk 51 can be supplied to another image forming apparatus via the USB memory. Likewise, image data saved as a file in another image forming apparatus can be stored in the hard disk 51 via the USB memory.

In the present embodiment, image data supplied from another image forming apparatus via the transmitting/receiving section 50 or the USB device connecting section 52 is subjected to an image conversion process in the preceding image processing section 40, if possible, so that the subsequent image processing section 41 can process the image data. Then, the image data is stored in the hard disk 51.

The JPEG decompression section 49 converts the JPEG-compressed image data into RGB signals by decompression.

Before image data supplied from another image forming apparatus via the transmitting/receiving section 50 or the USB device connecting section 52 and stored in the hard disk 51 is outputted as an image from the image data output section 42, the image data is converted into RGB signals in the JPEG decompression section 49, supplied to the subsequent image processing section 41, and subjected to color space conversion and the like so as to be converted into CMYK signals that can be respectively processed by the image stations of the image forming apparatus A, and then the CMYK signals are stored and managed in the hard disks 43b, 43c, 43d, and 43e, respectively.

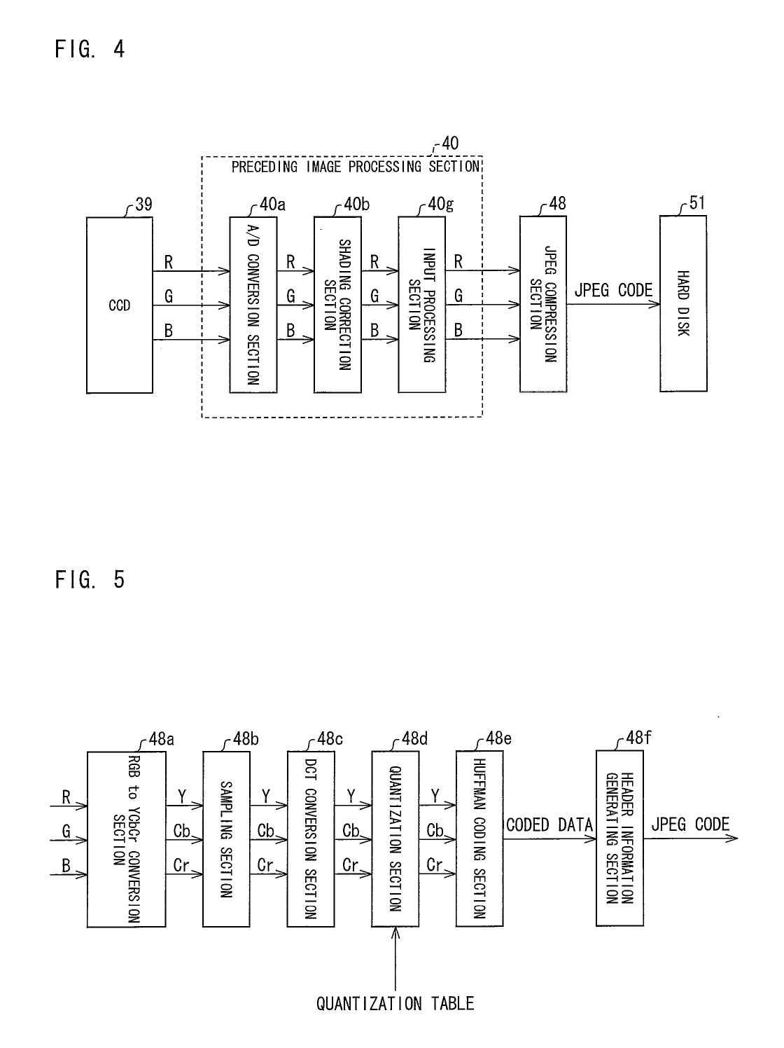

With reference to FIG. 4, the following describes steps of an image filing function of filing, in the hard disk 51, image data read out by the color CCD 39.

FIG. 4 briefly illustrates steps taken in the preceding image processing section 40 to apply JPEG compression on RGB signals. As shown in FIG. 4, RGB signals are supplied from the color CCD 39 via the preceding image processing section 40 to the JPEG compression section 48.

The preceding image processing section 40 includes: an A/D (analog/digital) conversion section 40a (not shown in FIG. 3) for converting an analog signal into a digital signal; the shading correction section 40b; an input processing section 40g including the line alignment section 40c, the sensor color correction section 40d, the MTF correction section 40e, the γ correction section 40f; and the like.

The color CCD 39 receives light reflected by a document, converts the light into electrical signals (RGB analog signals) by decomposing the light into RGB components, and then outputs the signals. The A/D conversion section 40a converts, into RGB digital signals, the color image signals (RGB analog signals) supplied from the color CCD 39. The shading correction section 40b eliminates, from the RGB digital signals, various distortions caused by an illumination system, image focusing system, and image sensing system of the color CCD 39. Then, the input processing section 40g performs line alignment, sensor color correction, MTF correction, γ correction, and the like on each of the RGB digital signals. All these image processing operations carried out in the preceding image processing section 40 are referred to as a “preceding stage of image processing”.

The JPEG compression section 48 receives the RGB image data supplied from the preceding image processing section 40 after being subjected to the preceding stage of image processing, and encodes the RGB image data with use of a preset quantization table and a preset sampling rate. The JPEG compression section 48 generates header information for every page and outputs, as JPEG code, the header information and coded data corresponding to the RGB image data.

FIG. 5 illustrates an arrangement of the JPEG compression section 48. Operation of the JPEG compression section 48 is described below with reference to FIG. 5. Note that all processes that are carried out in the JPEG compression section 48 are based on a standard JPEG compression algorithm.

RGB signals supplied from the preceding image processing section 40 are converted by an RGB-to-YcbCr conversion section 48a into a Y signal representing luminance information and Cb and Cr signals representing hue information. The YCbCr signals are then supplied to a sampling section 48b so that the hue signals are subjected to pixel skipping according to a predetermined sampling rate (4:4:4, for example).

Then, the YCbCr signals outputted from the sampling section 48b are inputted to a DCT (Discrete Cosine Transform) conversion section 48c. The YCbCr signals are subjected to DCT conversion per block so as to be separated into 64 frequency components. In each block, a piece of data on the upper-left corner is a DC component, and the other 63 pieces of data are AC components.

The YCbCr signals separated into the frequency components are supplied to a quantization section 48d and subjected to quantization per block with use of predetermined quantization tables. The quantization tables are constituted by two types of table, i.e., a table for the luminance signal and a table for the hue signals, each of which is represented by 64 integral values.

The YCbCr signals thus quantized are supplied to a Huffman coding section 48e, rearranged in a line, and then encoded according to a predetermined Huffman coding table. The Huffman coding table is not particularly limited in value, and as such, uses values widely used in general.

Coded data outputted from the Huffman coding section 48e is inputted to a header information generating section 48f. The header information generating section 48f generates header information for every page and prepends the header information to the coded data, whereby JPEG code is outputted in a format that complies with the standards of JPEG images. In the header information, the quantization tables, the Huffman coding table, the sampling rate used in compression, the width/height of the image, and the like are sorted out by specified marker signs and described.

In the encoding process, the standard JPEG compression algorithm is used, and the header information to be prepended is in a standard data format. (Standard header information refers to header information in which the width/height of an image, a quantization table, a Huffman coding table, a sampling rate, and the like are sorted out by specified marker signs and described in sequence.)

The JPEG code obtained by the compression process as described above is transferred to a personal computer or the like via the interface 46. The present embodiment uses a JPEG method as a method for compressing image data. However, it is possible to use another compression method.

Although FIG. 4 shows an example of a process by which image data read out by the color CCD 39 is stored in the hard disk 51 via the JPEG compression section 48, it is also possible to store, in the hard disk 51 via the JPEG compression section 48, image data (RGB signals) taken by an image input apparatus and supplied via the first input interface section 46 and image data (RGB signals) transmitted in the form of an image file from a personal computer (image filing).

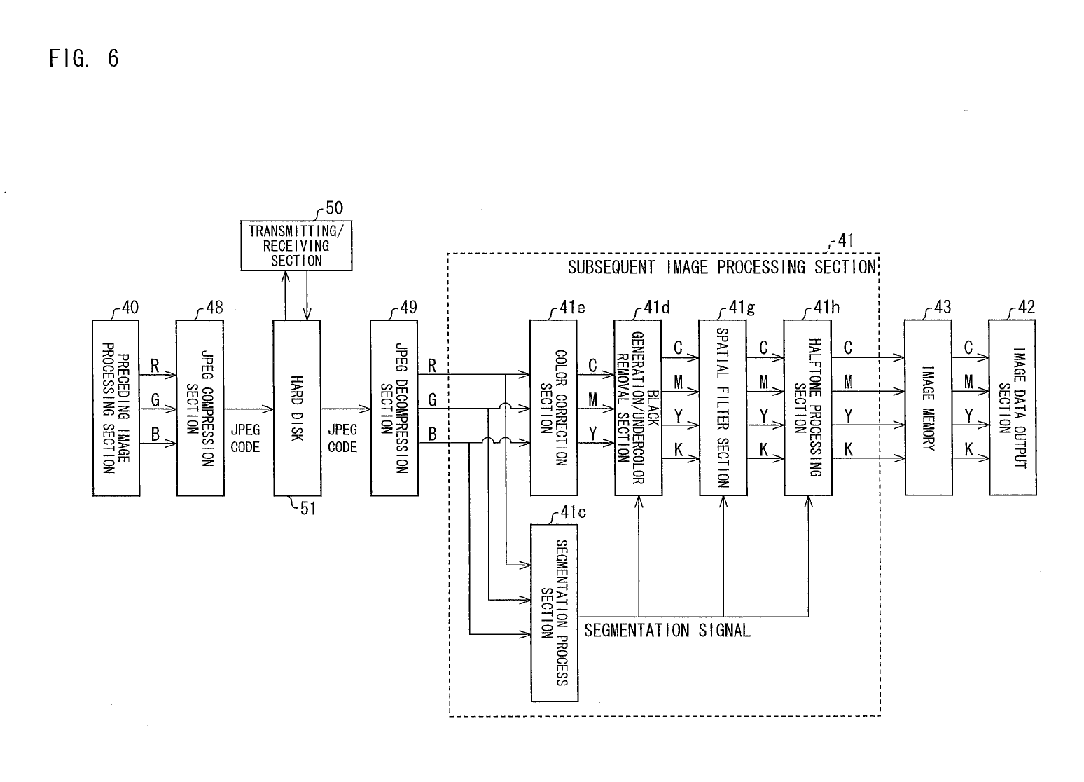

With reference to FIG. 6, the following describes steps of a procedure for reading out image data stored in the hard disk 51 and performing the subsequent stage of image processing on the image data in the subsequent image processing section 41. FIG. 6 omits the monochrome data generating section 41a, the input processing section 41b, the zoom processing circuit 41f, and the like from the subsequent image processing section 41.

JPEG code outputted from the JPEG compression section 48 is supplied to the hard disk 51. The JPEG code is temporarily saved as an image data file in the hard disk 51 and managed as such.

Once the image forming apparatus A is instructed to output an image from the image data output section 42, the JPEG code is supplied from the hard disk 51 to the JPEG decompression section 49.

The JPEG decompression section 49 decompresses the JPEG code into image data in the form of RGB signals by carrying out a process of deciphering header information prepended to the JPEG code, a process of decrypting coded data, and other processes. Note that all these processes are based on a standard JPEG decompression algorithm.

The image data thus decompressed is supplied to the color correction section 41e and segmentation process section 41c of the subsequent image processing section 41. The color correction section 41e generates CMY (C: cyan, M: magenta, Y: yellow) signals complementary to the RGB signals, and carries out a process that enhances color reproducibility. The CMY signals are converted by the black generation/undercolor removal section 41d into CMYK (K: black) signals. The CMYK signals are subjected to an enhancement process and a smoothing process in the spatial filter section 41g. Then, the CMYK signals are subjected to tone reproduction in the halftone processing section 41h.

The segmentation process section 41c judges which type of region each pixel of the image data belongs to, e.g., which region each pixel belongs to among a black text, a color text region, a halftone dot region, and the like. The segmentation process section 41c supplies segmentation signals to the black generation/undercolor removal section 41d, the spatial filter section 41g, and the halftone processing section 41h so that the segmentation signals are subjected to appropriate processes according to the type of region.

The CMYK signals supplied from the halftone processing section 41h are temporarily stored in the image memory 43. Then, the CMYK signals are supplied at an appropriate timing to the image data output section 42, which includes the four image forming stations (image forming sections), so that a final output image is formed. Note that the final output image is formed by an image reproducing apparatus such as an electrophotographic printer or an inkjet printer.

The execution of the preceding stage of image processing and the subsequent stage of image processing in the same image forming apparatus A causes the preceding stage of image processing and the subsequent stage of image processing to be compatible with each other. This allows successful image-quality adjustment.

However, as mentioned in Background Art, there are also such cases that image data stored in the hard disk 51 by the image filing function is sent to another image forming apparatus via the transmitting/receiving section 50 and outputted by the destination image forming apparatus (or sent by facsimile), and that image data stored in a hard disk of another image forming apparatus is sent to the transmitting/receiving section 50 and printed out by the image data output section 42.

In these cases, the preceding stage of image processing and the subsequent stage of image processing are carried out in different image forming apparatuses. This causes incompatibility between the preceding stage of image processing and the subsequent stage of image processing, thus causing a problem of degradation in image quality.

This problem occurs also in the case of image data supplied via the first input interface section 46. At the point of time where the image data is compressed by the JPEG compression section 48 and stored in the hard disk 51, the image data is not necessarily in a form compatible with the subsequent stage of image processing to be carried out in the subsequent image processing section 41. This also causes incompatibility between the preceding stage of image processing and the subsequent stage of image processing, thus causing a problem of degradation in image quality.

In view of the problem, the image forming apparatus A of the present embodiment is arranged as below.

FIG. 1(a) shows an arrangement of a processing section for carrying out an image filing function of storing, in the hard disk 51, image data read out by the color CCD 39.

As shown in FIG. 1(a), a related-information adding section 63 is provided between the preceding image processing section 40 and the JPEG compression section 48. The related-information adding section 63 adds related information that enables a destination image forming apparatus to determine the contents of a preceding stage of image processing carried out by the preceding image processing section 40 of the image forming apparatus A.

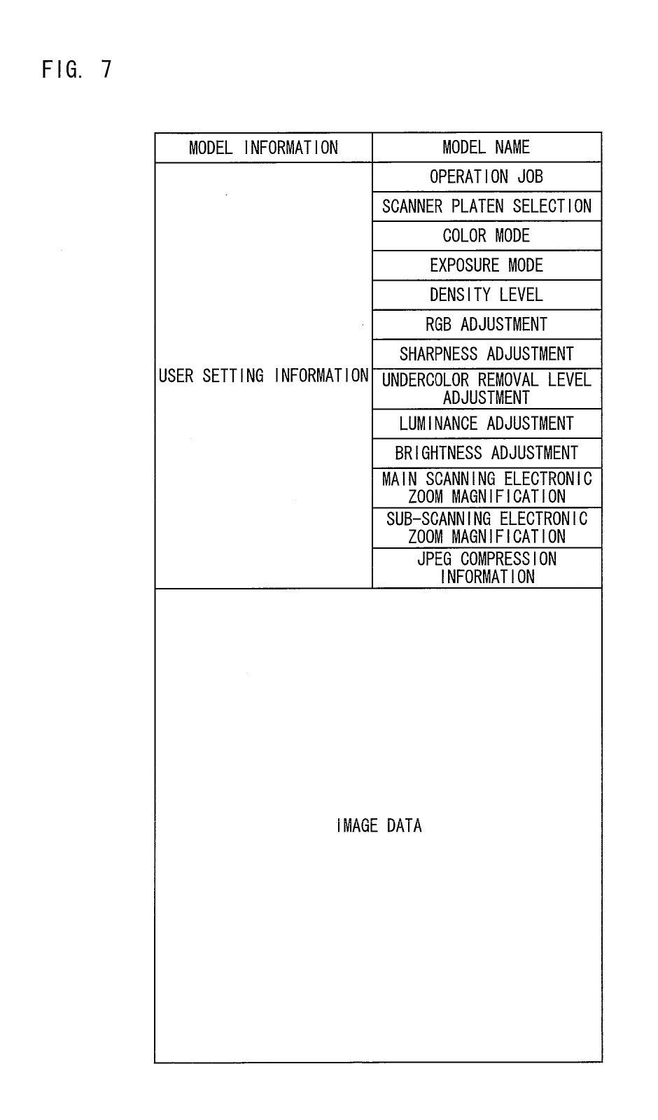

The related information added by the related-information adding section 63 is, for example, the model name of the image forming apparatus A or module information of ASIC constituting the preceding image processing section 40. As shown in FIG. 7, the related-information adding section 63 adds the related information to header information that is to be prepended to image data. As exemplified in FIG. 7, the header information includes MODEL INFORMATION (MODEL NAME) as the related information in addition to user setting information such as OPERATION JOB, SCANNER PLATEN SELECTION, and COLOR MODE.

The JPEG compression section 48 applies JPEG compression on the image data to which the related information is added. Then, the image data thus compressed is stored in the hard disk 51.

As described above, when the image forming apparatus A of the present embodiment has been instructed to carry out the image filing function, the related information (for example, the model name of the image forming apparatus A) is added to the image data that has been read out by the color CCD 39 and processed by the preceding image processing section 40 and that is to be subjected to the JPEG compression and stored in the hard disk 51. This enables the destination image forming apparatus to determine the contents of the preceding stage of image processing carried out by the preceding image processing section 40.

The destination image forming apparatus determines, from the related information, the contents of the preceding stage of image processing performed on the image data saved as a file, and performs an image conversion process on the image data so that the image data can be compatibly subjected to a subsequent stage of image processing in a subsequent image processing section of the destination image forming apparatus. This makes it possible to output an image whose quality has been successfully adjusted.

In FIG. 1(a), the related information is added to the image data supplied from the preceding image processing section 40 and to be stored in the hard disk 51. However, the related information can be added to image data stored in the hard disk 51 and to be outputted via the transmitting/receiving section 50 or the USB device connecting section 52.

FIG. 1(b) shows an arrangement of a processing section by which the image forming apparatus A receives JPEG-compressed image data from another image forming apparatus via the transmitting/receiving section 50 or the USB device connecting section 52 and carries out an image filing function of storing the image data in the hard disk 51.

As shown in FIG. 1(b), the compressed image data received via the transmitting/receiving section 50 or the USB device connecting section 52 is sent to a related-information detecting section 64 for detecting whether or not the image data has related information added thereto. In a case where the image data has related information added thereto, the related-information detecting section 64 sends the related information to an image conversion process selecting section 65 and sends the image data to the JPEG decompression section 49. The image conversion process selecting section 65 selects an image conversion process as appropriate according to the contents of a preceding stage of image processing carried out by a preceding image processing section of the source image forming apparatus.

The image conversion process selected by the image conversion process selecting section 65 is a process for eliminating excess and deficiency between the preceding stage of image processing carried out by the preceding image processing section of the source image forming apparatus and a subsequent stage of image processing that is to be carried out by the subsequent image processing section of the image forming apparatus A, which serves as a destination image forming apparatus (which receives the image data), i.e., an image conversion process by which the image data that has been subjected to the preceding stage of image processing in the source image forming apparatus can be made equivalent to image data that has been subjected to a preceding stage of image processing in the preceding image processing section 40 of the image forming apparatus A.

In the image forming apparatus A of the present embodiment, the image conversion process selected by the image conversion process selecting section 65 is carried out by the preceding image processing section 40 under control of the central processing unit 44. Before the execution of the image conversion process in the preceding image processing section 40, the image data is decompressed by the JPEG decompression section 49. After the execution of the image conversion process, the image data is compressed again by the JPEG compression section 48 and then stored in the hard disk 51.

Thus, even in a case where there may be degradation in image quality of image data outputted after being subjected by the image forming apparatus A only to a subsequent stage of image processing incompatible with the preceding stage of image processing carried out by the source image forming apparatus, it is possible to print out a high-quality image whose quality has been adequately adjusted.

Note however that, in a case where the image data has no related information added thereto or where the image conversion process selecting section 65 cannot select an appropriate image conversion process even though the image data has related information added thereto, that is to say, where the model name can be detected but there is no image conversion process corresponding to the model name, the related-information detecting section 64 directly sends the image data to the hard disk 51 and saves the image data in the hard disk 51 in a conventional manner.

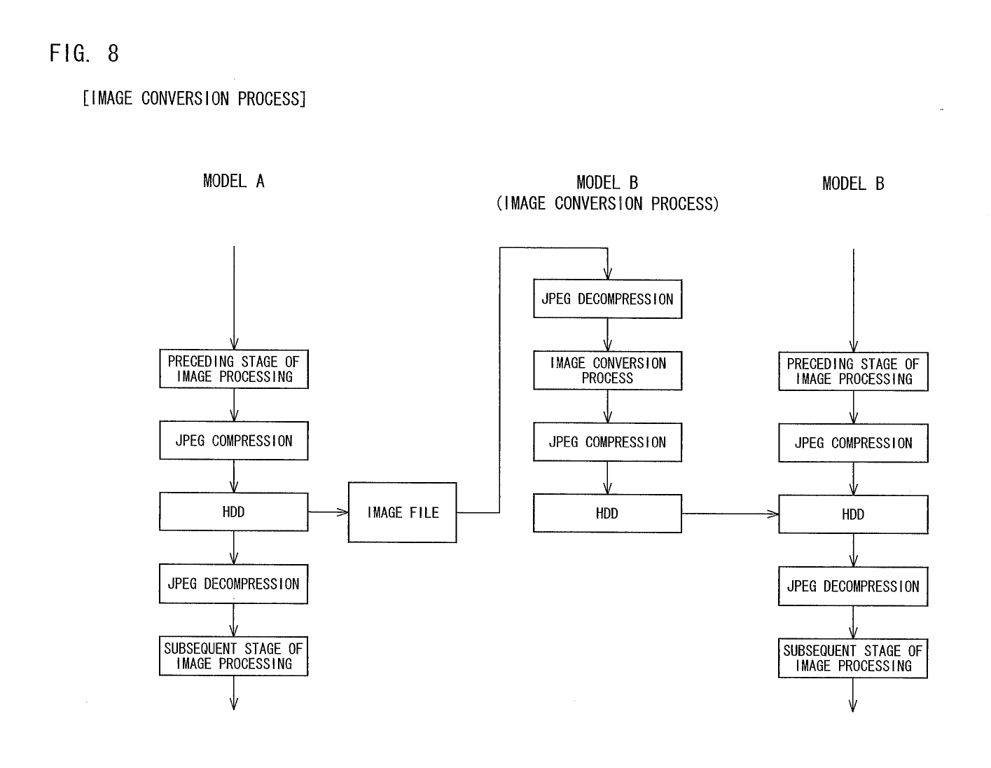

FIG. 8 shows an image conversion process to be performed on image data supplied from the image forming apparatus A (MODEL A) to an image forming apparatus of MODEL B. As with the image forming apparatus A, the image forming apparatus of MODEL B also has the function of detecting whether or not image data has related information added thereto and, in a case where the image data has related information added thereto, detecting the contents of a preceding stage of image processing carried out by a source image forming apparatus from which the image data has been supplied, selecting an image conversion process, and causing its preceding image processing section to carry out the image conversion process.

As shown on the right and left in FIG. 8, each of MODELS A and B performs a preceding stage of image processing on image data inputted thereto, applies JPEG compression on the image data, and then stores the image data as an image file in a hard disk. In printing out the image data stored in the hard disk, the image forming apparatus reads out the image file from the hard disk, applies JPEG decompression, and then carries out a subsequent stage of image processing.

As shown in the center part of FIG. 8, an image file supplied from the image forming apparatus of MODEL A to the image forming apparatus of MODEL B is subjected to an image conversion process before being stored in the hard disk of the image forming apparatus of MODEL B. That is to say, the image forming apparatus of MODEL B applies JPEG decompression on the received image file, caries out an image conversion process in a preceding image processing section thereof, applies JPEG compression on the image data, and then stores the image data in the hard disk.

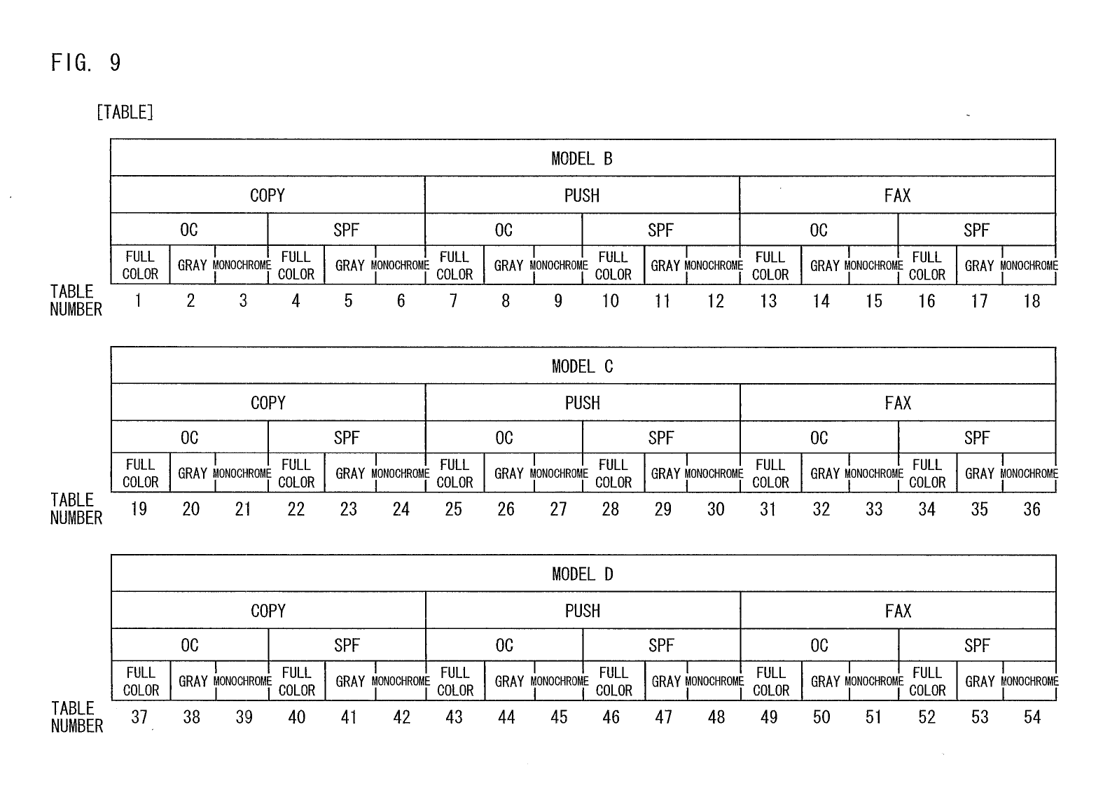

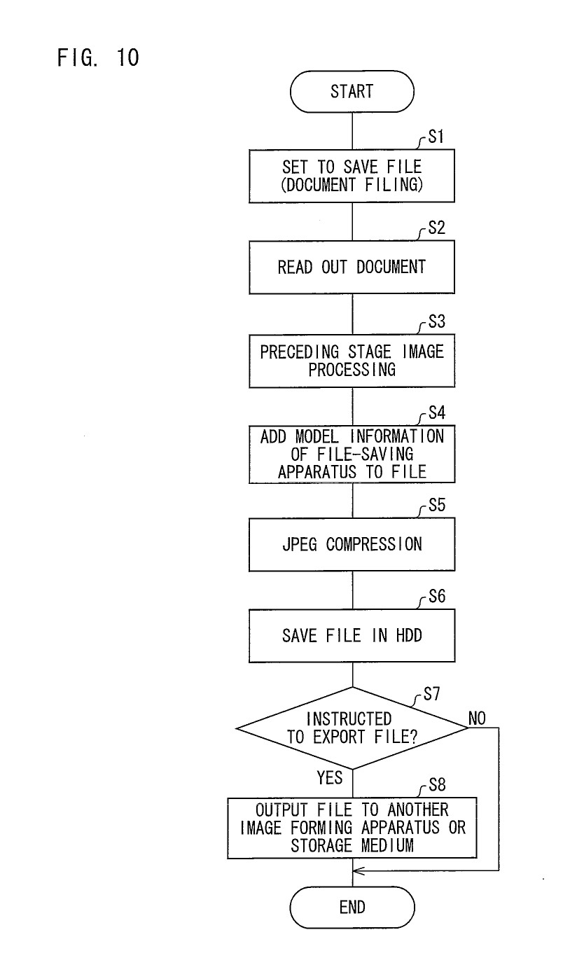

FIG. 9 shows how the image conversion process selecting section 65 of the image forming apparatus A of the present embodiment appropriately selects an image conversion process according to a model name prepended to image data supplied from a source image forming apparatus.

As shown in FIG. 9, the image forming apparatus A selects appropriate image conversion processes from a table for three types of image forming apparatuses, i.e., MODELS B, C, and D, according to combinations of three types of user setting information, i.e., operation job (COPY, PUSH, FAX), scanner platen selection (OC, SPF), and color mode (FULL COLOR, GRAY, MONOCHROME).

For example, in a case where the image forming apparatus A receives, from the image forming apparatus of MODEL B, image data whose header information includes user setting information indicating the operation job “COPY”, the scanner platen selection “SPF”, and the color mode “FULL COLOR”, the image forming apparatus A causes the preceding image processing section to subject the image data to an image conversion process corresponding to TABLE NO. “4”.

In the present embodiment, the related-information adding section 63 is provided so as to add related information. However, it is possible to directly use any information, originally included in header information prepended to the image data, which can determines the contents of a preceding stage of image processing carried out by a source image forming apparatus.

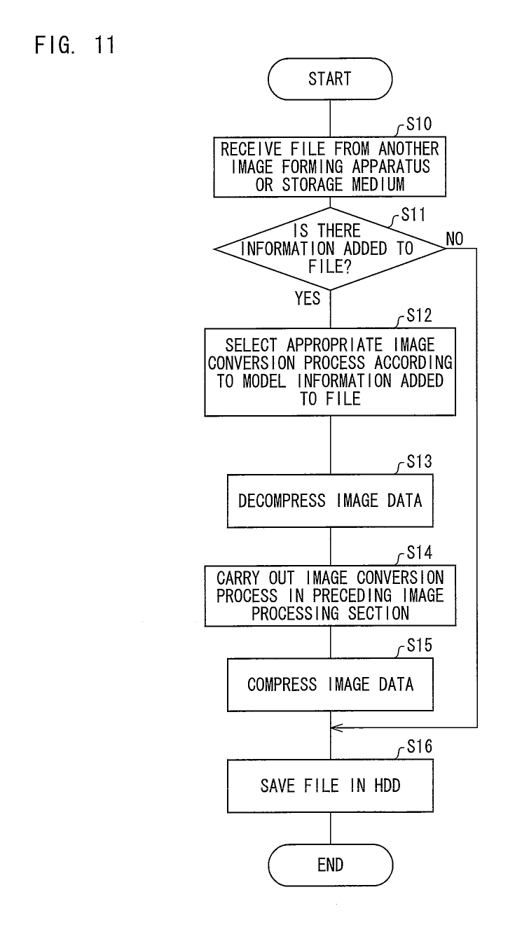

With reference to FIG. 10, the following describes steps of a procedure in which the image forming apparatus A carries out an image filing function of storing image data and outputs the image data. FIG. 10 is a flow chart showing steps of a procedure for causing the scanner (color CCD 39) to read out an image from a document, carrying out a filing function of storing the image as image data in the hard disk 51, and outputting the image data to another image forming apparatus.

When instructed by a user to carry out an image filing function of saving an image of a document placed on a scanner platen (OC) or an automatic document feeder (SPF) (saving a file) (S1), the image forming apparatus A causes the scanner to read out image data from the document (S2). Then, the image forming apparatus A subjects the image data to a preceding stage of image processing such as shading correction and γ correction as shown in FIG. 3 (S3). Then, the image forming apparatus A adds, to the image data, related information such as ASIC used in the preceding stage of image processing and the model name of the image forming apparatus A which has carried out the preceding stage of image processing, or correlates the image data with such information (S4). Then, the image data is compressed (S5) and stored in the hard disk 51 (S6).

When the image forming apparatus A is thereafter instructed by the user to output the image data saved as a file in the hard disk 51 (S7), the image data selected by the user and the related information are outputted via the transmitting/receiving section 50 and supplied to another image forming apparatus over a network, or outputted to a storage medium such as a USB memory via the USB device connecting section 52 (S8).

As above, when the image forming apparatus A outputs, to another image forming apparatus, image data saved as a file after being subjected to a preceding stage of image processing, the image forming apparatus A adds, to the image data, related information that enables the destination image forming apparatus to determine the contents of the preceding stage of image processing. Therefore, even in a case where the image forming apparatus A has transferred its stored image data to another image forming apparatus, the destination image forming apparatus can determine the contents of a preceding stage of image processing and perform an image conversion process on the image data so that the image data can be compatibly subjected to a subsequent stage of image processing. This makes it possible to output an image with high reproducibility even when the image data is of high resolution.

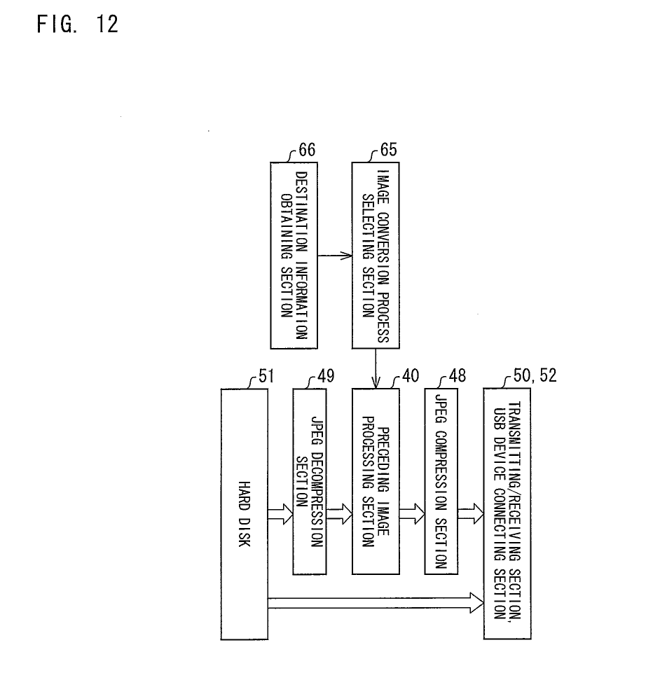

With reference to FIG. 11, the following describes steps of a procedure in an image forming apparatus that receives image data saved as a file and outputted as shown in FIG. 10.

Once the destination (receiving) image forming apparatus receives, via a transmitting/receiving section or a USB device connecting section, image data saved as a file after being subjected to a preceding stage of image processing in another image forming apparatus (S10), the destination image forming apparatus detects whether or not the image data has related information added thereto (S11). In a case where the image data has related information added thereto, the destination image forming apparatus determines the contents of the preceding stage of image processing from the related information, and selects such an image conversion process that the image data becomes compatible with the destination image forming apparatus (S12). Then, after decompressing the image data (S13), the destination image forming apparatus performs the image conversion process on the image data with use of a preceding image processing section (S14).

The image data, which has been changed into a form compatible with the destination image forming apparatus, is compressed (S15), and then stored in a hard disk.

When the destination image forming apparatus is thereafter instructed by a user to print out the image data, the image data is subjected to a printing process after being subjected to a subsequent stage of image processing.

As above, even when a destination image forming apparatus receives image data saved as a file in a source image forming apparatus of a different model, the destination image forming apparatus carries out, as an image conversion process, a preceding stage of image processing compatible with the model of the destination image forming apparatus, so that the image data can be compatibly subjected to a subsequent stage of image processing in the destination image forming apparatus. This makes it possible to output an image with high reproducibility.

Further, in a case where the image forming apparatus A of the present embodiment receives image data supplied from an image input apparatus via the first input interface, or image data transmitted as an image file from an information processing apparatus, and stores the image data in the hard disk or prints out the image data without storing it in the hard disk, the image forming apparatus A of the present embodiment (i) determines, from model information or the like attached to the image data, the contents of a preceding stage of image processing performed on the image data, (ii) performs an image conversion process on the image data so that the image data can be compatibly subjected to a subsequent stage of image processing in the image forming apparatus A, and then (iii) stores the image data in the hard disk or prints out the image data.

### Embodiment 2

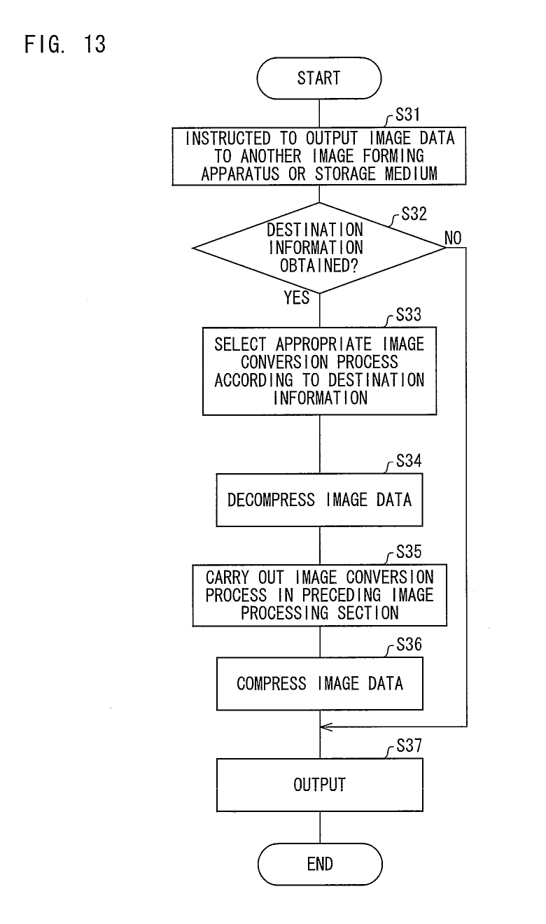

Another embodiment of the present invention is described below with reference to FIGS. 12 and 13.

For convenience of explanation, components having the same functions as those used in Embodiment 1 are given the same reference numerals, and as such, are not described below.

In Embodiment 1, a destination image forming apparatus having received image data that has been subjected to a preceding stage of image processing performs an image conversion process on the image data so that the image data can be compatibly subjected to a subsequent stage of image processing by a subsequent image processing section of the destination image forming apparatus.

In contrast, an image forming apparatus of the present embodiment performs an image conversion process on image data according to related information such as the model name of a destination image forming apparatus (which receives the image data) and then outputs the image data.

As shown in FIG. 12, once the source image forming apparatus is instructed to output image data stored as a file in a hard disk 51, a destination information obtaining section 66 obtains information that enables the source image forming apparatus to determine the contents of a preceding stage of image processing that is carried out by the destination image forming apparatus, e.g., model information of the destination image forming apparatus. Then, an image conversion process selecting section 65 selects such an image conversion process that the image data can be compatibly subjected to a subsequent stage of image processing by a subsequent image processing section of the destination image forming apparatus. Then, the source image forming apparatus performs the image conversion process on the image data in a preceding image processing section 40 of the source image forming apparatus, and then outputs the image data via a transmitting/receiving section 50 or a USB device connecting section 52.

For example, in a case where the image data is outputted via the transmitting/receiving section 50, the model information of the destination image forming apparatus is correlated in advance with address information of the destination image forming apparatus. This enables the destination information obtaining section 66 to determine the model of the destination image forming apparatus from the address information.

Alternatively, in a case where the image data is outputted via the USB device connecting section 52, a user may use a screen or the like to input some sort of information, such as the model name of the destination image forming apparatus, which enables the image conversion process selecting section 65 to select an image conversion process.

As in Embodiment 1, the image conversion process selecting section 65 selects an image conversion process required for the image data to be compatibly subjected to a subsequent stage of image processing in the destination image forming apparatus (which receives the image data), that is to say, to be equivalent to image data that has been subjected to a preceding stage of image processing in a preceding image processing section of the destination image forming apparatus.

As in Embodiment 1, in a case where the model of the destination image forming apparatus cannot be determined or where there is no image conversion process available for the model, the image data read out from the hard disk 51 is directly sent to the transmitting/receiving section 50 or the USB device connecting section 52 without passing through a JPEG decompression section 49, a preceding image processing section 40, or a JPEG compression section 48.

FIG. 13 is a flow chart showing steps of a procedure in which the image forming apparatus of the present embodiment outputs, to another image forming apparatus, image data stored in the hard disk by a filing function.

Once the source image forming apparatus is instructed to output, via the transmitting/receiving section 50 or the USB device connecting section 52 to another image forming apparatus, image data saved as a file after being subjected to a preceding stage of image processing (S31), the source image forming apparatus tries to obtain model information and the like of the destination image forming apparatus (S32). In a case where the source image forming apparatus succeeds in obtaining such information, the source image forming apparatus selects, according to the information, such an image conversion process that the image data becomes compatible with the destination image forming apparatus (S33). Then, after decompressing the image data read out from the hard disk 51 (S34), the source image forming apparatus performs the image conversion process on the image data with use of a preceding image processing section 40 (S35).

The image data, which has been changed into a form compatible with the destination image forming apparatus, is compressed (S36), and then outputted via the transmitting/receiving section 50 or the USB device connecting section 52 (S37).

As above, when the source image forming apparatus outputs, to another image forming apparatus, image data that has been subjected to a preceding stage of image processing, the source image forming apparatus performs an image conversion process on the image data so that the image data can compatibly subjected to a subsequent stage of image processing in the destination image forming apparatus. Therefore, even in a case where different image forming apparatuses carry out a preceding stage of image processing and a subsequent stage of image processing separately, it is possible to print out an image whose quality has been successfully adjusted.

Finally, the blocks of the image forming apparatuses of the first and second embodiment, especially the related-information adding section 63, the related-information detecting section 64, and the image conversion process selecting section 65, may be realized by way of hardware or software as executed by a CPU as follows.

The image forming apparatuses each include a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the image forming apparatuses a computer-readable storage medium containing control program code (executable program, intermediate code program, or source program) for the image forming apparatuses A and B, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The image forming apparatuses may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (Registered Trademark), 802.11 wireless, HDR, mobile telephone network, satellite line, or terrestrial digital network. The present invention encompasses a carrier wave or data signal transmission in which the program code is embodied electronically.

In order to attain the object, a first image forming apparatus of the present invention is an image forming apparatus, having an image filing function of storing input image data in a storage section thereof, which carries out a series of image processing operations separately as a preceding stage of image processing and a subsequent stage of image processing in order to output an image of appropriate quality according to input image data, and which carries out the image filing function in such a manner as to store, in the storage section, image data that has been subjected to the preceding stage of image processing, the image forming apparatus comprising: an input section for receiving, from a source image forming apparatus, image data that has been subjected to a preceding stage of image processing in the source image forming apparatus; and image conversion means for performing an image conversion process on the image data so that the image data is compatibly subjected to the subsequent stage of image processing in the image forming apparatus, the image conversion means carrying out the image conversion process according to that related information, attached to the image data, which enables the image forming apparatus to determine contents of the preceding stage of image processing carried out in the source image forming apparatus.

In this arrangement, the image conversion means performs the image conversion process on the image data, which has been subjected to the preceding stage of image processing in the source image forming apparatus and supplied via the input section from the source image forming apparatus, so that the image data can be compatibly subjected to the subsequent stage of image processing in the image forming apparatus. In this regard, the image conversion means carries out the image conversion process according to the related information, attached to the image data, which enables the image forming apparatus to determine the contents of the preceding stage of image processing carried out in the source image forming apparatus.

Thus, even in a case where different image forming apparatuses carry out a preceding stage of image processing and a subsequent stage of image processing separately on image data, it is possible to output an image whose quality has been successfully adjusted.

The related information is, for example, model information of the source image forming apparatus or module information of that image processing section, provided in the source image forming apparatus, which carries out the preceding stage of image processing in the source image forming apparatus.

In order to attain the object, a second image forming apparatus of the present invention is an image forming apparatus, having an image filing function of storing input image data in a storage section thereof, which carries out a series of image processing operations separately as a preceding stage of image processing and a subsequent stage of image processing in order to output an image of appropriate quality according to input image data, and which carries out the image filing function in such a manner as to store, in the storage section, image data that has been subjected to the preceding stage of image processing, the image forming apparatus comprising: an output section for outputting, to a destination image forming apparatus, image data that has been subjected to the preceding stage of image processing and stored in the storage section; and related-information adding means for adding, to image data that has been subjected to the preceding stage of image processing, related information that enables the destination image forming apparatus to determine contents of the preceding stage of image processing carried out in the image forming apparatus.

In this arrangement, the related-information adding means adds, to the image data to be stored in the storage section, the related information that enables the destination image forming apparatus to determine the contents of the preceding stage of image processing carried out in the image forming apparatus. That is to say, the image data that has been subjected to the preceding stage of image processing is stored in the storage section together with the related information that specifies the contents of the preceding stage of image processing.

In a case where the destination image forming apparatus is the first image forming apparatus of the present invention, the destination image forming apparatus can determine the contents of the preceding stage of image processing from the related information attached to the image data, and can carry out the image conversion process so that the image data can be compatibly subjected to a subsequent stage of image processing in a subsequent image processing section of the destination image forming apparatus.

Thus, even in a case where different image forming apparatuses carry out a preceding stage of image processing and a subsequent stage of image processing separately on image data, it is possible to output an image whose quality has been successfully adjusted.

In order to attain the object, a third image forming apparatus of the present invention is an image forming apparatus, having an image filing function of storing input image data in a storage section thereof, which carries out a series of image processing operations separately as a preceding stage of image processing and a subsequent stage of image processing in order to output an image of appropriate quality according to input image data, and which carries out the image filing function in such a manner as to store, in the storage section, image data that has been subjected to the preceding stage of image processing, the image forming apparatus comprising: an output section for outputting, to a destination image forming apparatus, image data that has been subjected to the preceding stage of image processing and stored in the storage section; and image conversion means for performing an image conversion process on the image data, which is to be outputted via the output section, so that the image data is compatibly subjected to a subsequent stage of image processing in the destination image forming apparatus, the image conversion means carrying out the image conversion process according to contents of a preceding stage of image processing that is carried out in the destination image forming apparatus.

In this arrangement, the image conversion means performs the image conversion process on the image data, which is to be outputted via the output section, so that the image data can be compatibly subjected to the subsequent stage of image processing in the destination image forming apparatus. In this regard, the image conversion means carries out the image conversion process according to the contents of the preceding stage of image processing that is carried out in the destination image forming apparatus.

Thus, even in a case where different image forming apparatuses carry out a preceding stage of image processing and a subsequent stage of image processing separately on image data, it is possible to output an image whose quality has been successfully adjusted.

Each of the first and third image forming apparatuses according to the present invention can be further arranged such that the image conversion means carries out the image conversion process with use of an image processing section for carrying out the preceding stage of image processing in the image forming apparatus.

It is also possible to provide another image processing section for carrying out the image conversion process. However, this causes an increase in cost. Alternatively, it is also possible to carry out the image conversion process with use of an image processing section for carrying out a subsequent stage of image processing. However, this requires a larger amount of data than to carry out the image conversion process with use of an image processing section for carrying out a preceding stage of image processing, thus causing an increasing in cost related to development. Use of an image processing section for carrying out a preceding stage of image processing makes it possible to carry out the image conversion process most efficiently.

The first image forming apparatus of the present invention can be arranged so that: the image filing function allows image data from an image input apparatus or an information processing apparatus to be stored in the storage section; and the image conversion means performs the image conversion process on the image data according to that related information, attached to the image data, which enables the image forming apparatus to determine contents of image processing carried out in the image input apparatus or the information processing apparatus.

In this arrangement, the image conversion means performs the image conversion process on image data supplied from a mobile communication terminal or an image input apparatus such as a digital camera or a digital video camera, as well as image data supplied from another image forming apparatus. In this regard, the image conversion means carries out the image conversion process according to related information, attached to the image data, which indicates the contents of image processing performed on the image data. This allows the image data to be compatibly subjected to the subsequent stage of image processing in the image forming apparatus.

This arrangement makes it possible to output, according to image data supplied from an image input apparatus, as well as image data supplied from another image forming apparatus, an image whose quality has been successfully adjusted.

An image input apparatus according to the present invention performs image processing on image data received thereby, and then outputs the image data via an output section to a destination image forming apparatus. The image input apparatus includes related-information adding means for adding, to the image data to be outputted via the output section, related information that enables the destination image forming apparatus to determine contents of the image processing.

In this arrangement, as with the related-information adding means of the image forming apparatus, the related-information adding means of the image input apparatus adds, to the image data, the related information that enables the destination image forming apparatus to determine the contents of the image processing.

Therefore, by arranging the first image forming apparatus of the present invention as the destination image forming apparatus, it is possible to output an image whose quality has been successfully adjusted.

Each of the means of the image forming apparatus may be realized by a computer. In this case, a program for causing a computer to operate as each of the means and a computer-readable storage medium in which the program has been stored are also encompassed in the scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. An image forming apparatus, having an image filing function of storing input image data in a storage section thereof, which carries out a series of image processing operations separately as a preceding stage of image processing and a subsequent stage of image processing in order to output an image of appropriate quality according to input image data, and which carries out the image filing function in such a manner as to store, in the storage section, image data that has been subjected to the preceding stage of image processing, the image forming apparatus comprising:
an input section for receiving, from a source image forming apparatus, image data that has been subjected to a preceding stage of image processing in the source image forming apparatus; and
image conversion means for performing an image conversion process on the image data so that the image data is compatibly subjected to the subsequent stage of image processing in the image forming apparatus, the image conversion means carrying out the image conversion process according to that related information, attached to the image data, which enables the image forming apparatus to determine contents of the preceding stage of image processing carried out in the source image forming apparatus.

2. The image forming apparatus according to claim 1, wherein the image conversion means carries out the image conversion process with use of an image processing section for carrying out the preceding stage of image processing in the image forming apparatus.

3. The image forming apparatus according to claim 1, wherein the related information is model information of the source image forming apparatus or module information of that image processing section, provided in the source image forming apparatus, which carries out the preceding stage of image processing in the source image forming apparatus.

4. The image forming apparatus according to claim 1, wherein:
the image filing function allows image data from an image input apparatus or an information processing apparatus to be stored in the storage section; and
the image conversion means performs the image conversion process on the image data according to that related information, attached to the image data, which enables the image forming apparatus to determine contents of image processing carried out in the image input apparatus or the information processing apparatus.

5. An image forming apparatus, having an image filing function of storing input image data in a storage section thereof, which carries out a series of image processing operations separately as a preceding stage of image processing and a subsequent stage of image processing in order to output an image of appropriate quality according to input image data, and which carries out the image filing function in such a manner as to store, in the storage section, image data that has been subjected to the preceding stage of image processing, the image forming apparatus comprising:
an output section for outputting, to a destination image forming apparatus, image data that has been subjected to the preceding stage of image processing and stored in the storage section; and
related-information adding means for adding, to image data that has been subjected to the preceding stage of image processing, related information that enables the destination image forming apparatus to determine contents of the preceding stage of image processing carried out in the image forming apparatus.

6. The image forming apparatus according to claim 5, wherein the related information is model information of the image forming apparatus or module information of an image processing section, provided in the image forming apparatus, which carries out the preceding stage of image processing.

7. An image forming apparatus, having an image filing function of storing input image data in a storage section thereof, which carries out a series of image processing operations separately as a preceding stage of image processing and a subsequent stage of image processing in order to output an image of appropriate quality according to input image data, and which carries out the image filing function in such a manner as to store, in the storage section, image data that has been subjected to the preceding stage of image processing, the image forming apparatus comprising:
an output section for outputting, to a destination image forming apparatus, image data that has been subjected to the preceding stage of image processing and stored in the storage section; and
image conversion means for performing an image conversion process on the image data, which is to be outputted via the output section, so that the image data is compatibly subjected to a subsequent stage of image processing in the destination image forming apparatus, the image conversion means carrying out the image conversion process according to contents of a preceding stage of image processing that is carried out in the destination image forming apparatus.

8. The image forming apparatus according to claim 7, wherein the image conversion means carries out the image conversion process with use of an image processing section for carrying out the preceding stage of image processing in the image forming apparatus.
